(19) United States
(12) Patent Application Publication
(10) Pub. No.: US 2018/0268616 A1
(43) Pub. Date: Sep. 20, 2018

(54) METHOD AND APPARATUS FOR GENERATING 3D PRINTING DATA

(71) Applicant: ELECTRONICS AND TELECOMMUNICATIONS RESEARCH INSTITUTE, Daejeon (KR)

(72) Inventors: Yoon Seok CHOI, Daejeon (KR); Seung Woo NAM, Daejeon (KR); Soon Chul JUNG, Daejeon (KR); In Su JANG, Daejeon (KR); Jin Seo KIM, Daejeon (KR)

(21) Appl. No.: 15/919,613

(22) Filed: Mar. 13, 2018

(30) Foreign Application Priority Data
Mar. 16, 2017 (KR) 10-2017-0032940

(51) Int. Cl. G06T 19/20; G06T 15/04; B29C 64/20; B29C 64/393; B33Y 30/00; B33Y 50/02

(52) U.S. Cl. CPC G06T 19/20; G06T 15/04; B29C 64/20; G06T 2219/2021; B33Y 30/00; B33Y 50/02; B29C 64/393

(57) ABSTRACT

A method of generating 3D printing data performed by an apparatus for generating 3D printing data includes generating a 3D model of an object; generating a surface height map from a texture image indicating a surface texture of the object; setting an area in which the surface height map is projected on a surface of the 3D model; slicing the 3D model into a plurality of cross-section segments; and correcting a shape of at least a portion among the cross-section segments in consideration of the area in which the surface height map is projected on the 3D model.

### CROSS-REFERENCE TO RELATED APPLICATION

This application claims priority to Korean Patent Application No. 10-2017-0032940, filed Mar. 16, 2017 in the Korean Intellectual Property Office (KIPO), the entire content of which is hereby incorporated by reference.

### BACKGROUND

### 1. Field of the Invention

The present disclosure generally relates to method and apparatus for generating 3D printing data. More particularly, the present disclosure relates to method and apparatus for generating 3D printing data capable of reflecting a surface texture of an object.

### 2. Description of Related Art

A 3D printer refers to a device that manufactures a 3D object based on data designed in three dimensions. Since the introduction of a 3D printer in 1987, development has progressed significantly. Various types of printing methods such as an FDM, an SLS, and a photo-curing method have been introduced. A 3D printer has been widely used in the field of aircrafts, vehicles, medical, construction, sculpture, and the like, and ordinary people may easily print their own 3D model to manufacture an actual object. In addition, as print quality of the 3D printer is improved, it is possible to print an object having high quality and precise surface texture.

The 3D printer may receive data designed in three dimensions and print an object. The data designed in three dimensions may include information on a 3D shape of the object to be print. The data designed in three dimensions described above is referred to as a 3D model.

In order to increase the print quality of the 3D printer, high detailed 3D model is required. For example, in order to precisely express the surface of a printing object, the 3D model is required to represent the texture of the object's surface. In order to represent the texture of the object surface, the number of polygons and vertices configuring the 3D model is required to be increased, and thus the amount of polygons or vertices of the 3D model is increased. Therefore, a lot of time may be required for the 3D printer to display the 3D model on a monitor or to process the 3D model.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure has been made keeping in mind the above problems occurring in the related art, and the present disclosure is intended to propose method and apparatus for generating 3D printing data. According to the present disclosure, 3D printing data capable of expressing a texture of an object can be generated with a small amount of polygons.

In order to achieve the objective of the present disclosure, a method of generating 3D printing data performed by an apparatus for generating 3D printing data may comprise generating a 3D model of an object; generating a surface height map from a texture image representing a surface texture of the object; setting an area in which the surface height map is projected on a surface of the 3D model; slicing the 3D model into a plurality of cross-section segments; and correcting a shape of at least a portion among the cross-section segments in consideration of the area in which the surface height map is projected on the 3D model.

The method may further comprise determining surface heights of each pixel of the surface height map, based on at least one of a color and a brightness of each pixel of the texture image.

The correcting the shape of at least the portion among the cross-section segments may comprise determining whether or not each of the cross-section segments includes the area on which the surface height map is projected, and correcting the shape of the cross-section segment including the area on which the surface height map is projected.

The correcting the shape of at least the portion among the cross-section segments may comprise correcting a shape of a side surface of at least the portion among the cross-section segments.

The correcting the shape of at least the portion among the cross-section segments may comprise correcting positions of vertices included in the area on which the surface height map is projected, among vertices included in the side surface of the cross-section segment.

The correcting the shape of at least the portion among the cross-section segments may comprise determining surface heights of each of vertices included in the area on which the surface height map is projected, using the surface height map, and correcting positions of each of vertices, based on the surface heights of each of vertices.

The surface heights of each of vertices may be determined as surface heights of pixels corresponding to the vertices in the surface height map, respectively.

The surface heights of each of vertices may be determined by a linear sum of surface heights of pixels corresponding to the vertices in the surface height map, respectively, and surface heights of pixels adjacent to positions on which the vertices may be mapped, respectively.

The setting the area in which the surface height map is projected on the surface of the 3D model may comprise receiving reference point information for setting a projection position of the surface height map in the 3D model, and determining the area on which the surface height map is projected, based on the reference point and a border shape of the texture image.

In order to achieve the objective of the present disclosure, an apparatus for generating 3D printing data may comprise a processor; and a memory configured to store at least one instruction executed through a learning database and the processor. Also, the at least one instruction may be performed to generate a 3D model of an object, generate a surface height map from a texture image indicating a surface texture of the object, set an area in which the surface height map is projected on a surface of the 3D model, slice the 3D model into a plurality of cross-section segments, and correct a shape of at least a portion among the cross-section segments in consideration of the area in which the surface height map is projected on the 3D model.

The at least one instruction may be performed to determine surface heights of each pixel of the surface height map, based on at least one of a color and a brightness of each pixel of the texture image.

The at least one instruction may be performed to determine whether or not each of the cross-section segments includes the area on which the surface height map is projected, and correct the shape of the cross-section segment including the area on which the surface height map is projected.

The at least one instruction may be performed to correct a shape of a side surface of at least the portion among the cross-section segments.

The at least one instruction may be performed to correct positions of vertices included in the area on which the surface height map is projected, among vertices included in the side surface of the cross-section segment.

The at least one instruction may be performed to determine surface heights of each of vertices included in the area on which the surface height map is projected, using the surface height map, and correct positions of each of vertices, based on the surface heights of each of vertices.

The surface heights of each of vertices may be determined as surface heights of pixels corresponding to the vertices in the surface height map, respectively.

The surface heights of each of vertices may be determined by a linear sum of surface heights of pixels corresponding to the vertices in the surface height map, respectively, and surface heights of pixels adjacent to positions on which the vertices may be mapped, respectively.

The apparatus may further comprise an input interface device configured to receive reference point information for setting a projection position of the surface height map in the 3D model; and an print interface device configured to display the 3D model, the reference point, and projection position of the surface height map, wherein the at least one instruction is performed to determine the area on which the surface height map is projected, based on the reference point and a border shape of the texture image.

In order to achieve the objective of the present disclosure, a 3D printer may comprise a processor; a memory configured to store at least one instruction executed through a learning database and the processor; and a manufacturing apparatus configured to manufacture an object in a shape determined by an instruction of the processor. Also, the at least one instruction may be performed to generate a 3D model of the object, generate a surface height map from a texture image indicating a surface texture of the object, set an area in which the surface height map is projected on a surface of the 3D model, slice the 3D model into a plurality of cross-section segments, and correct a shape of at least a portion among the cross-section segments in consideration of the area in which the surface height map is projected on the 3D model.

The manufacturing apparatus may manufacture the object by laminating materials in a shape corresponding to each of cross-section segments from a cross-section segment positioned at the lowermost end among cross-section segments of which the correction is completed.

According to the disclosed embodiments, 3D printing data capable of expressing a surface texture of an object can be generated without a direct modification of a 3D model. In addition, an environment in which a user may select a texture image and easily set an area where the texture of the texture image is reflected in the 3D model can be provided. In addition, a calculation amount for the 3D printing data capable of expressing the surface texture of the object and the capacity of the 3D printing data can be reduced.

### BRIEF DESCRIPTION OF DRAWINGS

Embodiments of the present disclosure will become more apparent by describing in detail embodiments of the present disclosure with reference to the accompanying drawings, in which:

FIG. 1 is a block diagram illustrating a 3D printing data generation apparatus 100 according to an exemplary embodiment;

FIGS. 2A and 2B are images of a 3D model and an object on a display;

FIG. 3 is a flowchart illustrating a method of generating 3D printing data by the 3D printing data generation apparatus according to an exemplary embodiment of the present disclosure;

FIGS. 4A to 4D are images illustrating texture images;

FIG. 5 is a conceptual diagram illustrating a process of generating a surface height map from the texture image;

FIG. 6 illustrates an image displayed on a printing interface device in a process of setting a projection area of the surface height map;

FIG. 7 is a conceptual diagram illustrating an area in which the surface height map is projected on a surface of the 3D model;

FIGS. 8 and 9 are conceptual diagrams illustrating a process of determining the area on which the surface height map is projected by the processor;

FIG. 10 is a conceptual diagram illustrating a process of slicing the 3D model into cross-sectional segments;

FIG. 11 is a conceptual diagram illustrating the cross-sectional segments divided from the 3D model by the slicing shown in FIG. 10;

FIG. 12 is a flowchart illustrating a process of performing step S150 of FIG. 3;

FIG. 13 is a conceptual diagram illustrating a position change of vertices by a correction of the slice;

FIG. 14 is a conceptual diagram illustrating a process of determining a surface height of the point of slice contour by the processor;

FIG. 15 is a conceptual diagram illustrating another example of a process of determining the surface height of the point of slice contour by the processor; and

FIG. 16 is a block diagram illustrating a 3D printer according to an exemplary embodiment of the present disclosure.

### DETAILED DESCRIPTION OF THE INVENTION

Embodiments of the present disclosure are disclosed herein. However, specific structural and functional details disclosed herein are merely representative for purposes of describing embodiments of the present disclosure, however, embodiments of the present disclosure may be embodied in many alternate forms and should not be construed as limited to embodiments of the present disclosure set forth herein.

Accordingly, while the present disclosure is susceptible to various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in detail with reference to the accompanying drawings. Throughout the drawings, the same reference numerals will refer to the same or like parts.

In the present disclosure, a 3D model is 3Dly designed data and refers to data including information on a 3D shape. Slicing refers to a process of dividing a 3D model into a plurality of cross-sectional segments. The cross-section segment refers to data indicating one layer when a shape of an object is divided into a plurality of layers. A texture image refers to an image indicating a texture of an object surface. The texture image may be a two-dimensional image. A surface height map is generated from the texture image. In order to express the texture, the surface height map may include information on how to change the surface height of the 3D model. 3D printing data refers to data used in printing an object by a 3D printer. The 3D printing data may be obtained by correcting a shape of at least a portion of the cross-sectional segments using the surface height map.

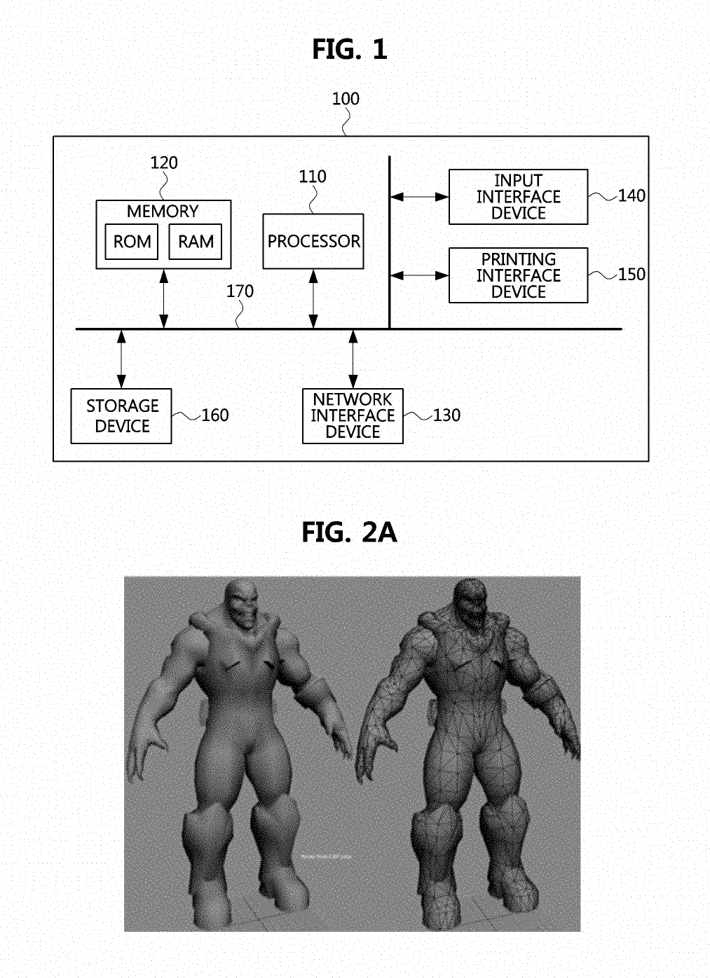

FIG. 1 is a block diagram illustrating a 3D printing data generation apparatus 100 according to an exemplary embodiment.

Referring to FIG. 1, the 3D printing data generation apparatus 100 according to an exemplary embodiment may include at least one processor 110, a memory 120, a storage device 160, and the like.

The processor 110 may execute a program stored in at least one of the memory 120 and the storage device 160. The processor 110 may refer to a central processing unit (CPU), a graphics processing unit (GPU), or a dedicated processor on which methods in accordance with embodiments of the present disclosure are performed. Each of the memory 120 and the storage device 160 may be constituted by at least one of a volatile storage medium and a non-volatile storage medium. For example, the memory 120 may comprise at least one of read-only memory (ROM) and random access memory (RAM).

The memory 120 and/or the storage device 160 may store at least one instruction executed by the processor 110. The at least one instruction may be configured to generate a 3D model in which a texture of an object surface is not reflected, generate a surface height map from a texture image, set an area in which the surface height map is projected on a surface of the 3D model, slice the 3D model into a plurality of cross-section segments, and correct a shape of at least a portion among the cross-section segments in consideration of the area in which the surface height map is projected on the 3D model.

The processor 110 may generate the 3D model in accordance with the at least one instruction stored in the memory 120 and/or the storage device 160. The processor 110 may slice the 3D model into the cross-section segments. The processor 110 may generate the surface height map from the texture image and correct the shape of at least a portion of the cross-section segments based on the surface height map. After the correction, the cross-section segments may be utilized as 3D printing data.

The 3D printing data generation apparatus 100 may further include an input interface device 140, a printing interface device 150, the storage device 160, and the like. Each element included in the 3D printing data generation apparatus 100 may be connected by a bus 170 and may communicate with each other.

The input interface device 140 may be configured of a button, a touch screen, an input device of a normal PC, and the like. The input interface device 140 may receive information on a selection of the texture image, the position where a surface height map generated from the texture image is projected on the 3D model, and the like, from the user. The print interface device 150 may visually display information related to an input of the user, an object indicated by the 3D model, a process of generating the 3D printing data, and the like.

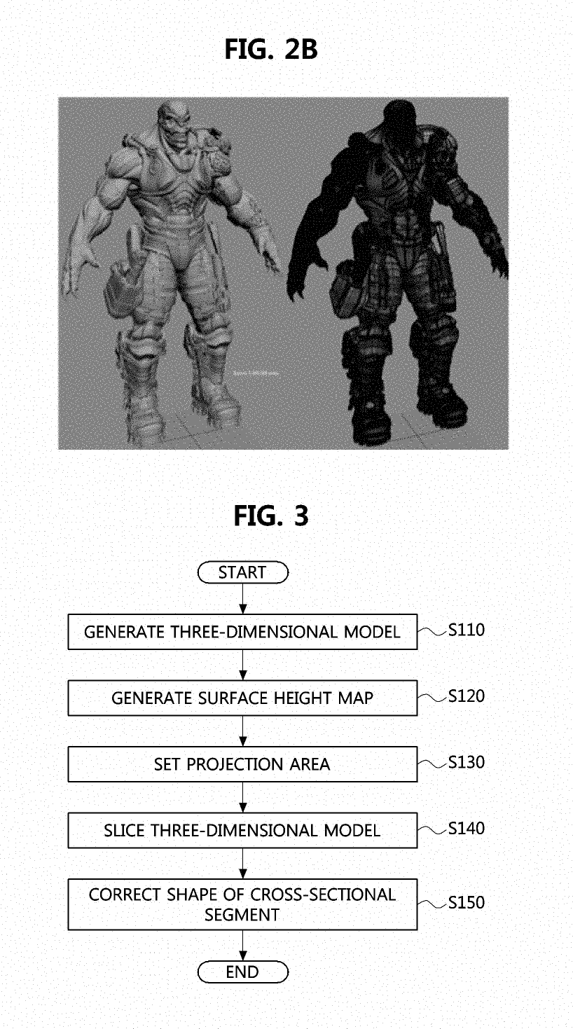

FIGS. 2A and 2B are images of the 3D model and a screen display of 3D model.

In FIGS. 2A and 2B, each of the left images shows the shape of the 3D model, and each of the right images shows the 3D model of the object. In addition, FIG. 2A shows a case in 3D model without texture, and FIG. 2B shows a 3D model with texture.

Referring to FIGS. 2A and 2B, the 3D model may indicate the surface of the object as a set of polygons. The 3D model may set the position of vertices according to the shape of the object to be expressed and may indicate the surface of the object as the set of the polygons defined by the vertices.

Referring to FIG. 2A, in a case in which the number of the vertices and the number of the polygons of the 3D model is small, the surface texture of the object may be relatively simply expressed. On the other hand, referring to FIG. 2B, in a case in which the number of the vertices and the number of the polygons of the 3D model is large, the surface texture of the object may be precisely expressed. The surface texture indicates properties of the surface, and may include irregularities, winkles, roughness, and the like of the surface.

As required quality of 3D printing has increased, required resolution of the 3D model has also increased. In order to precisely represent the surface of the object, the 3D model is required to include a large number of polygons and vertices. In a case in which the number of the polygons and the vertices included in the 3D model increases, the capacity of the 3D model and the calculation amount for the 3D model may be increased. In this case, a lot of time and calculation resources may be required for the 3D printer to display and process the 3D model.

FIG. 3 is a flowchart illustrating a method of generating 3D printing data by the 3D printing data generation apparatus 100 according to an exemplary embodiment of the present disclosure.

Referring to FIG. 3, in step S110, the processor 110 may generate the 3D model. The 3D model may indicate the surface of the object by the vertices and the polygons. The processor 110 may does not reflect the texture of the surface or may reflect the texture of the surface with relatively low precision to generate the 3D model.

In step S120, the processor 110 may generate the surface height map from the texture image. The texture image may be an image indicating the texture of the surface. The texture image may be a two-dimensional image. The texture image may be an image stored in the memory 120 of the 3D printing data generation apparatus 100 in advance. Alternatively, the processor 110 may generate the texture image according to the input of the user and store the texture image in the memory 120.

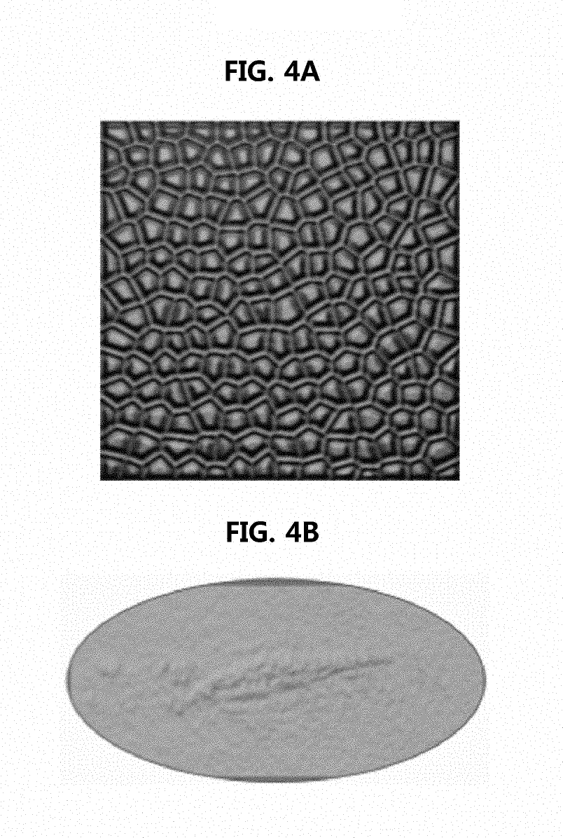

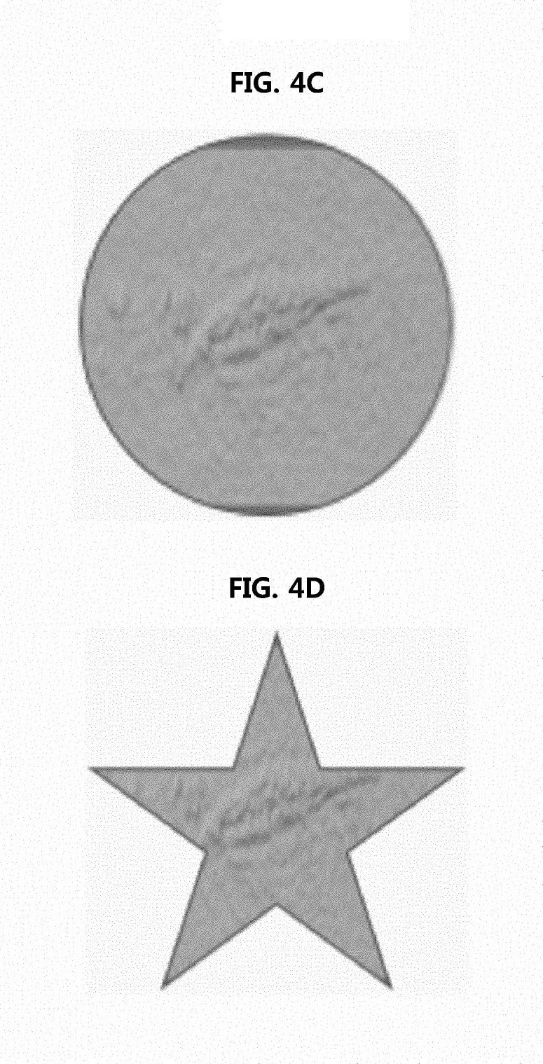

FIGS. 4A to 4D are images illustrating the texture images.

Referring to FIGS. 4A to 4D, according to the surface texture indicated by the texture image, the color or brightness of each pixel of the texture image may be changed. For example, in the texture image, a dark pixel may indicate an area where the surface height is low and a bright pixel may indicate an area where the surface height is high. According to a border shape of the texture image, a shape of an area on which the texture image is projected may be changed. The user may set the shape of the area on which the surface height map, which will be described later, is projected, by selecting the border shape of the texture image.

For example, the border of the texture image shown in FIG. 4A may have a rectangle shape. In a case in which the texture image shown in FIG. 4A is selected by the input of the user, the area on which the surface height map is projected may be set close to a rectangle. For example, in a case in which the surface of the 3D model is plane, the area on which the surface height map generated from the texture image of FIG. 4A is projected may be a rectangle shape. As another example, in a case in which the surface of the 3D model is a curved surface, the area on which the surface height map generated from the texture image of FIG. 4A may be determined as an area in which the rectangle shape is projected on the curved surface.

In addition, in a case in which the texture image shown in FIG. 4B is selected, the area on which the surface height map is projected may be set close to an ellipse shape. In a case in which the texture image shown in FIG. 4C is selected, the area on which the surface height map is projected may be set close to a circle shape. In a case in which the texture image shown in FIG. 4D is selected, the area on which the surface height map is projected may be set close to a star shape.

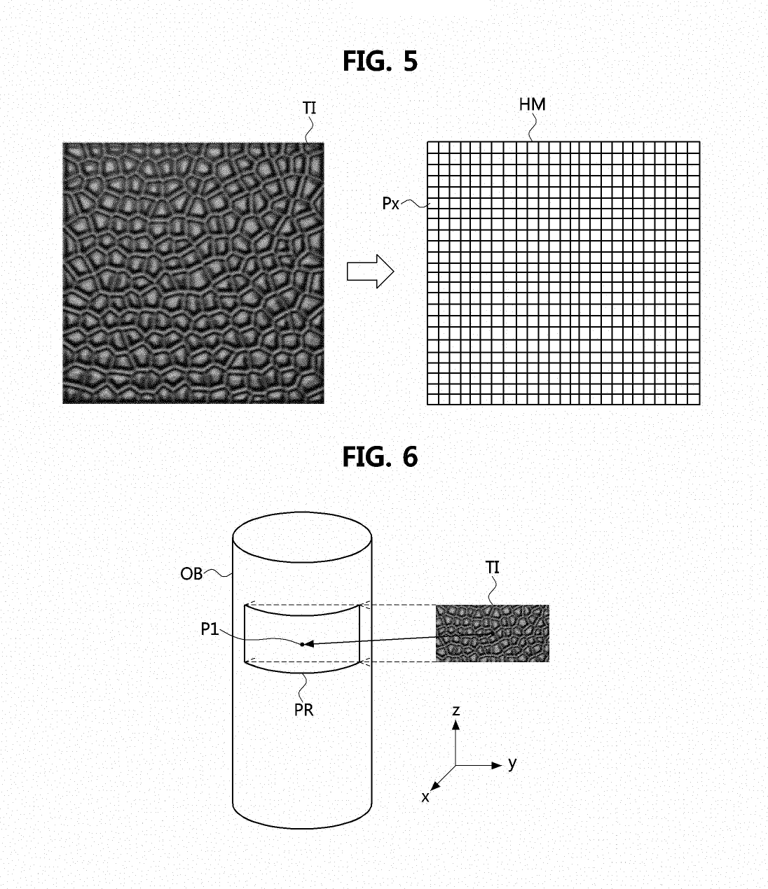

FIG. 5 is a conceptual diagram illustrating a process of generating a surface height map (HM) from a texture image (TI).

Referring to FIG. 5, the processor 110 may determine the surface height of each pixel of the surface height map HM, based on at least one of the color and the brightness of each pixel of the texture image TI. The surface height map (HM) may include a plurality of pixels (Px). Each pixel (Px) of the surface height map (HM) may correspond to each pixel of the texture image (TI). For example, the pixels (Px) of the surface height map (HM) and the pixels of the texture image (TI) may correspond one to one. As another example, in a case in which the resolution of the surface height map (HM) is set to be lower than that of the texture image TI, the number of the pixels (Px) included in the surface height map (HM) may be smaller than the number of the pixels included in the texture image (TI). In this case, data of the pixels of the texture image (TI) may be meshed to determine the surface height of the pixel (Px). The surface height map may be stored in the memory 120 in a matrix form. The memory 120 may store the surface height of each pixel of the surface height map as an element of the matrix.

The processor 110 may determine the value of the pixel (Px) of the surface height map (HM) in consideration of the color of each pixel of the texture image (TI). The processor 110 may determine the value of the pixel (Px) of the surface height map (HM) in consideration of RGB value of each pixel of the texture image TI. As another example, the processor 110 may determine the value of the pixel (Px) of the surface height map (HM) in consideration of the brightness value of each pixel of the texture image (TI). For example, in a case in which the pixel of the texture image (TI) corresponding to the pixel (Px) of the surface height map (HM) is bright, the processor 110 may set the value of the pixel (Px) to be high. In a case in which the pixel of the texture image TI corresponding to the pixel (Px) of the surface height map HM is dark, the processor 110 may set the value of the pixel (Px) to be low.

Referring to FIG. 3 again, in step S130, the processor 110 may set the area in which the surface height map is projected on the surface of the 3D model.

FIG. 6 illustrates an image displayed on the printing interface device 150 in a process of setting the projection area of the surface height map.

Referring to FIG. 6, the printing interface device 150 may display the shape of the 3D model (OB) and the texture image TI. The border shape and the internal shape of the selected texture image (TI), and a projection area (PR) where the surface of the 3D model (OB) is changed and a texture change shape of the surface may be determined.

The input interface device 140 may receive information on the position of a reference point (P1) from the user. In a case in which the input interface device 140 receives the information on the position of the reference point (P1), the processor 110 may correspond any one of the vertices of the 3D model to the reference point (P1). The processor 110 may set the area PR on which the surface height map is projected on the surface of the 3D model, based on a vertex corresponding to the reference point P1 and the border shape of the texture image (TI). The printing interface device 150 may display the projection area (PR) on which the surface height map is projected.

FIG. 6 shows a case in which the surface height map is projected only on a portion of the surface of the 3D model OB, but the exemplary embodiment is not limited thereto.

The processor 110 may cause the texture indicated by the texture image (TI) to be reflected on the entire surface of the 3D model (OB). For example, the processor 110 may project the surface height map generated from the texture image TI on the entire surface of the 3D model OB indicated by the 3D model. In this case, the process of receiving the information on the reference point P1 shown in FIG. 6 may be omitted.

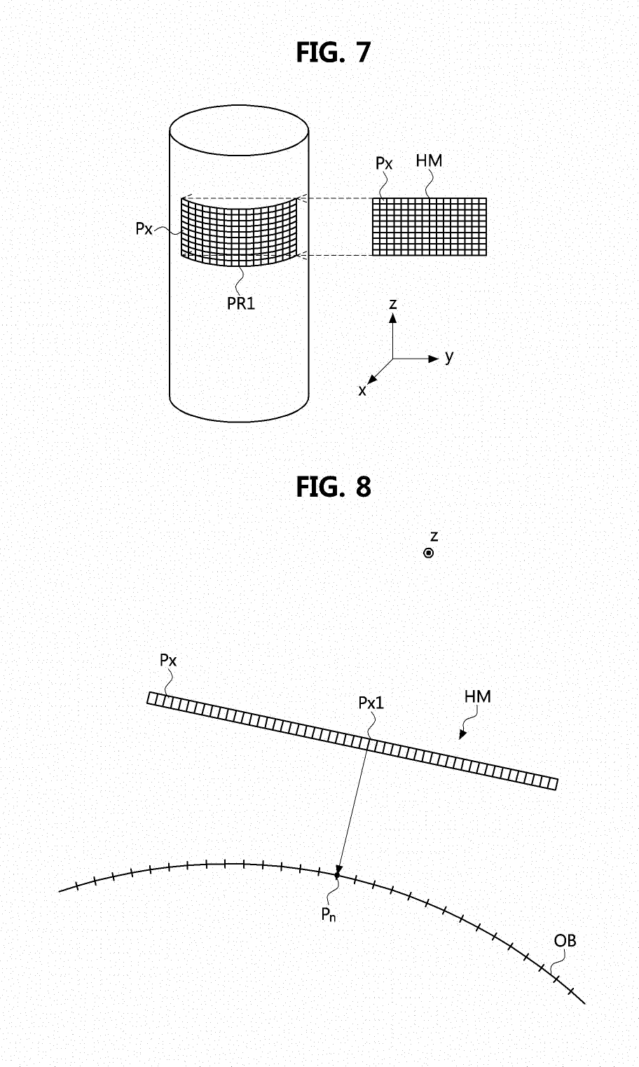

FIG. 7 is a conceptual diagram illustrating an area (PR1) in which the surface height map (HM) is projected on the surface of the 3D model.

According to the setting procedure shown in FIG. 6, the processor 110 may set the area (PR1) in which the surface height map (HM) generated from the texture image (TI) is to be projected on the 3D model (OB). The processor 110 may determine only the projection area (PR1) on which the surface height map (HM) is projected and may not modify the actual 3D model (OB). The processor 110 may store information on the projection area (PR1) on which the surface height map (HM) is projected in the memory 120. The processor 110 may determine the position of the surface of the 3D model (OB) on which the pixel (Px) of the surface height map (HM) is projected.

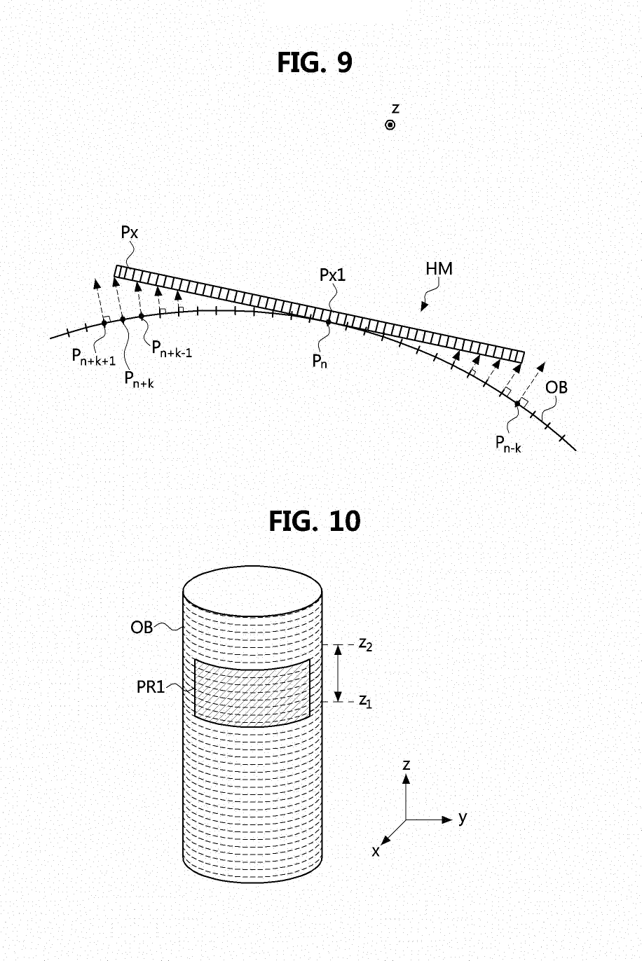

FIGS. 8 and 9 are conceptual diagrams illustrating a process of determining the projection area (PR1) on which the surface height map (HM) is projected by the processor 110.

FIGS. 8 and 9 show the 3D model (OB) and the surface height map (HM) viewed in a z-axis direction in FIG. 7.

Referring to FIG. 8, the processor 110 may select a vertex Pₙ corresponding to a reference point received by the input interface device 140 in the 3D model (OB). The processor 110 may move the surface height map (HM) so that a reference pixel Px1 of the surface height map (HM) meets the vertex Pₙ corresponding to the reference point. The reference pixel Px1 may be a pixel at the center of the surface height map (HM). As another example, the processor 110 may determine the reference pixel Px1 based on the user setting received by the input interface device 140.

Referring to FIG. 9, the processor 110 may perform a hit test on each of the vertices of the surface of the 3D model in a state in which the reference pixel (Px1) and the vertex Pₙ meet. The processor 110 may determine whether or not a normal vector for each of the vertices meets the surface height map (HM). For example, normal vectors for each of vertices between a vertex Pₙ₊ₖ and a vertex Pₙ₋ₖ may meet the surface height map (HM). In contrast, a normal vector for a vertex Pₙ₊ₖ₊₁ may not meet the surface height map (HM). Therefore, the processor 110 may set an area between the vertex Pₙ₊ₖ and the vertex Pₙ₋ₖ as the area on which the surface height map is projected.

The above description is merely illustrative, and the exemplary embodiment is not limited thereto. For example, the processor 110 may set the projection area by changing the surface height map to a curved surface similar or identical to the surface of the 3D model and then projecting the surface height map on the 3D model. Alternatively, the processor 110 may set the projection area by using a mathematical model which projects a plane on a 3D curved surface.

Referring to FIG. 3 again, in step S140, the processor 110 may slice the 3D model into a plurality of cross-sectional segments.

FIG. 10 is a conceptual diagram illustrating a process of slicing the 3D model (OB) into the cross-sectional segments.

Referring to FIG. 10, the processor 110 may slice the 3D model (OB) in a direction perpendicular to the z-axis direction. In FIG. 10, dotted lines indicate a boundary of the cross-sectional segments. In addition, the projection area (PR1) indicates the area on which the surface height map is projected. The area (PR1) may be positioned between the height z1 and the height z2 on a slicing axis (z-axis).

The processor 110 may slice the 3D model (OB) on which the surface texture indicated by the texture image is not reflected or the reflection degree of the surface texture is relatively small into the plurality of cross-sectional segments. According to the thickness (z-axis direction) of the cross-sectional segments, the resolution of the 3D printing data may be determined. For example, in a case in which the processor 110 sets the thickness of the cross-sectional segments so that the thickness of the cross-sectional segments is small, the number of the cross-sectional segments may be increased. On the other hand, in a case in which the processor 110 sets the thickness of the cross-sectional segments so that the thickness of the cross-sectional segments is large, the number of the cross-sectional segments may be reduced. In addition, the resolution of the 3D printing data may be reduced.

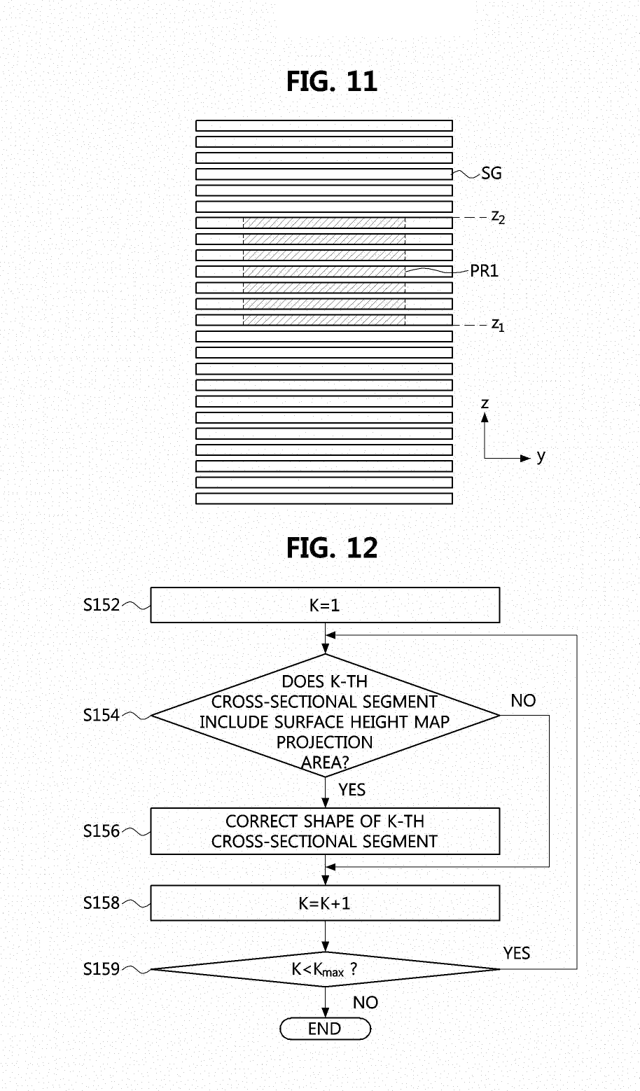

FIG. 11 is a conceptual diagram illustrating the cross-sectional segments (SG) divided from the 3D model by the slicing shown in FIG. 10.

FIG. 11 illustrates the cross-sectional segments (SG) viewed from a z-y plane. Referring to FIG. 11, the cross-sectional segments (SG) may include a cross section perpendicular to the z-axis direction. A shape of a side surface (a surface parallel to the z-axis direction) of the cross-sectional segments may be changed according to the shape of the 3D model. The cross-sectional segments (SG) between the height z1 and the height z2 in the z-axis direction which is the slicing axis may include the projection area (PR1) on which the surface height map is projected. The surface height map may be projected on a portion of the side surface of the cross-sectional segments (SG) between the height z1 and the height z2.

Referring to FIG. 3 again, in step S150, the processor 110 may correct the shape of at least a portion of the cross-sectional segments in consideration of the projection area (PR1) in which the surface height map is projected on the 3D model (OB).

FIG. 12 is a flowchart illustrating a process of performing step S150 of FIG. 3.

Referring to FIG. 12, in step S152, the processor 110 may set the K value indicating an index of the cross-sectional segment to 1. The index may be set so that the index of the lowest cross-sectional segment in the z-axis direction has the minimum value (for example, 1) and the index of the highest cross-section segment in the z-axis direction has the maximum value (for example, Kₘₐₓ).

In step S154, the processor 110 may determine whether or not a K-th cross-sectional segment includes the projection area (PR1) of the surface height map. That is, the processor 110 may determine whether or not the area (PR1) on which the surface height map is projected is present on the side surface of the K-th cross-sectional segment. For example, the processor 110 may determine that the cross-sectional segments between the z1 and the z2 in the z-axis direction include the projection area PR1 of the surface height map. In addition, the processor 110 may determine that cross-sectional segments positioned in the height lower than the z1 or higher than the z2 in the z-axis direction may not the projection area PR1 of the surface height map.

In a case in which the K-th cross-sectional segment does not include the projection area PR1 of the surface height map, the processor 110 may update the value of the index K in step S158.

In a case in which the K-th cross-sectional segment includes the projection area PR1 of the surface height map, the processor 110 may correct the shape of the K-th cross-sectional segment. For example, the processor 110 may correct the positions of the vertices included in the area PR1 on which the surface height map is projected, among the vertices included in the side surface of the K-th cross-sectional segment. The processor 110 may determine the height at which the vertices protrude from the surface of the 3D model according to the surface height of the pixels of the surface height map corresponding to the vertices. The processor 110 may correct the position of the vertices according to the height at which the vertices protrude. The processor 110 may correct the position of the vertices in a direction perpendicular to the surface on which the vertex is positioned.

After step S156 is completed, the processor 110 may update the value of the index K in step S158.

In step S159, the processor 110 may compare the index K with the maximum value Kₘₐₓ. In a case in which the index K is less than the Kₘₐₓ, the above-described steps S154 to S158 may be repeated. In a case in which the index K is not less than the Kₘₐₓ, the processor 110 may end the process of correcting the cross-sectional segment.

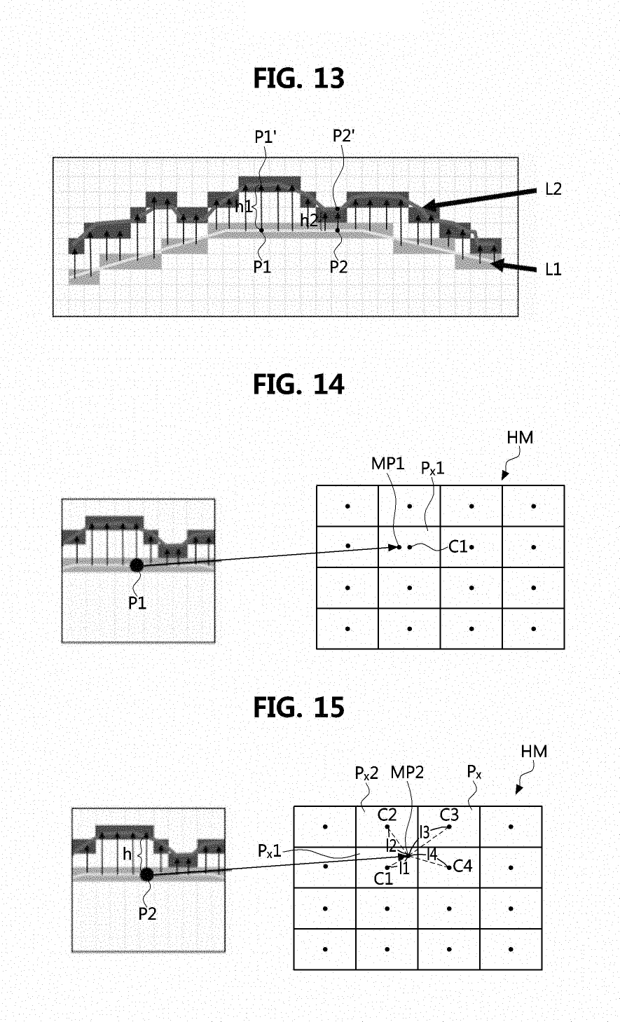

FIG. 13 is a conceptual diagram illustrating a position change of the points by the correction of the cross-sectional segment.

In FIG. 13, an L1 line denotes the shape of the side surface of the cross-sectional segment indicated by the vertices before the correction of the cross-sectional segment. An L2 line denotes the shape of the side surface of the cross-sectional segment indicated by the points after the correction of the cross-sectional segment.

Referring to FIG. 13, the processor 110 may determine the surface height of the vertices, based on the surface heights of the pixels of the surface height map. The processor 110 may correct the position of the points, based on the surface heights of the vertices. For example, in a case in which the surface height of a point P1 is h1, the processor 110 may determine a point spaced apart from the point P1 by h1 in a direction perpendicular to the surface as the position of a new point P1′. In addition, in a case in which the surface height of a point P2 is h2, the processor 110 may determine a point spaced apart from the point P2 by h2 in a direction perpendicular to the surface as the position of a new point P2′.

As shown in FIG. 13, in a case in which the processor 110 corrects the position of the vertices included in the side surface of the cross-sectional segments using the surface height map, although the 3D model is not directly modified, the 3D printing data may reflect the texture of the object. Therefore, according to the exemplary embodiment of the present disclosure, the surface texture may be reflected with a small operation amount compared to a case in which the 3D model is directly modified and handled.

The processor 110 may change the shape of the side surface of the cross-sectional segment so that the shape of the side surface of the cross-sectional segment is constant in the slicing axis direction (z-axis direction). The 3D printer may form a layer of a uniform shape in the z-axis direction in printing one cross-sectional segment. Therefore, in a case in which the processor 110 changes the shape of the side surface of the cross-sectional segment only on the xy plane perpendicular to the slicing axis direction (z-axis direction), only data reflected in the actual print process may be changed to reduce the operation amount.

FIG. 14 is a conceptual diagram illustrating a process of determining the surface height of the vertex by the processor 110.

Referring to FIG. 14, when the processor 110 projects the surface height map (HM) on the 3D model, the processor 110 may determine the position where a correction target point is mapped to the surface height map (HM). The correction target point refers to a vertex included in an area on which the surface height map (HM) is projected among the vertices included in the side surface of the cross-sectional segment. For example, the correction target point P1 may be mapped to a position MP1 in the surface height map (HM). The processor 110 may cause a pixel Px1 including the position MP1 to correspond to the point P1. The processor 110 may determine the surface height of the pixel P1 as the surface height of the point P1 and correct the position of the point P1.

In FIG. 14, the processor 110 determines the surface height of one pixel Px1 as the surface height of the point P1. However, the exemplary embodiment is not limited thereto. For example, the processor 110 may consider surface heights of a plurality of pixels in order to determine the surface height of the point.

FIG. 15 is a conceptual diagram illustrating another example of a process of determining the surface height of the point by the processor 110.

Referring to FIG. 15, the point P2 may be mapped to a position MP2 of the surface height map (HM). In a case in which the distance between the position MP2 and the center C1 of the pixel Px1 is relatively large, when only the surface height of the pixel Px1 is considered, the accuracy may be reduced. The processor 110 may calculate the surface height of the point P2 in consideration of the surface height of the pixel Px1 corresponding to the point P2 and the surface heights of pixels Px2, Px3, and Px4 adjacent to the position MP2 to which the point P2 is mapped.

For example, the surface height h of the point P2 may be calculated by Equation 1.

h=α₁h1+α₂h2+α₃h3+α₄h4 [Equation 1]

In Equation 1, h refers to the surface height of the point P2, h1 refers to the surface height of the pixel px1, h2 refers to the surface height of the pixel px2, h3 refers to the surface height of the pixel px3, and h4 refers to the surface height of the pixel px4. In addition, α₁ refers to weight of the pixel Px1, α₂ refers to weight of the pixel Px2, α₃ refers to weight of the pixel Px3, and α₄ refers to weight of the pixel Px4.

α₁ may depend on the distance 11 between the center C1 of the pixel P1 and the mapping position MP2. α₂ may depend on the distance 12 between the center C2 of the pixel P2 and the mapping position MP2. α₃ may depend on the distance 13 between the center C3 of the pixel P3 and the mapping position MP2. α₄ may depend on the distance 14 between the center C4 of the pixel P4 and the mapping position MP2.

Referring to Equation 1, the surface height of the point P2 may be determined as a linear sum of the surface height of the pixel Px1 corresponding to the vertex P2 in the surface height map (HM) and the surface heights h2, h3, and h4 of the pixels Px2, Px3, and Px4 adjacent to the position MP2 to which the vertex P2 is mapped in the surface height map (HM). As described with reference to FIG. 14, the processor 110 may increase the accuracy of the correction of the cross-sectional segment by determining the surface height of the point P2.

The apparatus and method for generating the 3D data according to the exemplary embodiments of the present disclosure have been described above with reference to FIGS. 1 to 14. According to the exemplary embodiments of the present disclosure, the 3D printing data capable of indicating the surface texture of the object can be generated without modifying the 3D model. The 3D printing data may include the cross-sectional segments. In addition, an environment in which the user may select the texture image and easily set the area where the texture of the texture image is reflected in the 3D model can be provided. In addition, the calculation amount for the 3D printing data capable of indicating the surface texture of the object and the capacity of the 3D printing data can be reduced.

Hereinafter, a 3D printer and a printing method of the 3D printer will be described.

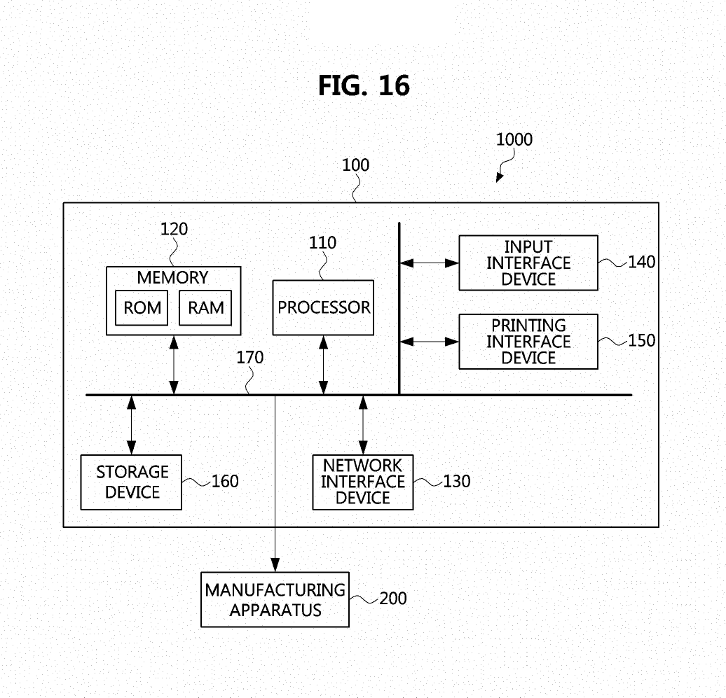

FIG. 16 is a block diagram illustrating a 3D printer 1000 according to an exemplary embodiment of the present disclosure. In the description of the exemplary embodiment of FIG. 16, the descriptions repetitive to FIG. 1 will be omitted.

Referring to FIG. 16, the 3D printer 1000 may include the 3D printing data generation apparatus 100 and a manufacturing apparatus 200.

The processor 110 may generate the printing data by the exemplary embodiments described with reference to FIGS. 3 to 15. The printing data may include a plurality of cross-sectional segments. The shape of at least a portion of the plurality of cross-sectional segments may be corrected. The processor 110 may transfer the 3D printing data to the manufacturing apparatus 200. The manufacturing apparatus 200 may identify the plurality of cross-sectional segments. The manufacturing apparatus 200 may form a layer corresponding to the shape of each cross-sectional segment from the cross-sectional segment positioned at the lowermost end among the plurality of cross-sectional segments.

The manufacturing apparatus 200 may form the layer corresponding to the shape of the cross-sectional segment using a liquid or power type material. For example, the manufacturing apparatus 200 may form the layer using extrusion processing, yarn processing, laser melting, thermal sintering, electron beam melting, a gypsum-based method, a photo-curable resin molding method, or the like.

The manufacturing apparatus 200 may form the layers corresponding to the cross-sectional segments, and sequentially laminate the layers from the lowermost end. The manufacturing apparatus 200 may manufacture the object by laminating the layers.

The embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. A method of generating 3D printing data performed by an apparatus for generating 3D printing data, the method comprising:
generating a 3D model of an object;
generating a surface height map from a texture image indicating a surface texture of the 3D model;
setting an area in which the surface height map is projected on a surface of the 3D model;
slicing the 3D model into a plurality of cross-section segments; and
correcting a shape of at least a portion among the cross-section segments in consideration of the area in which the surface height map is projected on the 3D model.

2. The method of claim 1, further comprising:
determining surface heights of each pixel of the surface height map, based on at least one of a color and a brightness of each pixel of the texture image.

3. The method of claim 1, wherein the correcting the shape of at least the portion among the cross-section segments comprises:
determining whether or not each of the cross-section segments includes the area on which the surface height map is projected; and
correcting the shape of the cross-section segment including the area on which the surface height map is projected.

4. The method of claim 1, wherein the correcting the shape of at least the portion among the cross-section segments comprises correcting a shape of a side surface of at least the portion among the cross-section segments.

5. The method of claim 4, wherein the correcting the shape of at least the portion among the cross-section segments comprises correcting positions of points included in the area on which the surface height map is projected, among vertices included in the side surface of the cross-section segment.

6. The method of claim 4, wherein the correcting the shape of at least the portion among the cross-section segments comprises:
determining surface heights of each of vertices included in the area on which the surface height map is projected, using the surface height map; and
correcting positions of each of points on border of the cross-section segment, based on the surface heights of each of vertices.

7. The method of claim 6, wherein the surface heights of each of vertices are determined as surface heights of pixels corresponding to the vertices in the surface height map, respectively.

8. The method of claim 6, wherein the surface heights of each of vertices are determined by a linear sum of surface heights of pixels corresponding to the vertices in the surface height map, respectively, and surface heights of pixels adjacent to positions on which the vertices are mapped, respectively.

9. The method of claim 1, wherein the setting the area in which the surface height map is projected on the surface of the 3D model comprises:
receiving reference point information for setting a projection position of the surface height map in the 3D model; and
determining the area on which the surface height map is projected, based on the reference point and a border shape of the texture image.

10. An apparatus for generating 3D printing data, the apparatus comprising:
a processor; and
a memory configured to store at least one instruction executed through a learning database and the processor,
wherein the at least one instruction is performed to:
generate a 3D model of an object;
generate a surface height map from a texture image indicating a surface texture of the object;
set an area in which the surface height map is projected on a surface of the 3D model;
slice the 3D model into a plurality of cross-section segments; and
correct a shape of at least a portion among the cross-section segments in consideration of the area in which the surface height map is projected on the 3D model.

11. The apparatus of claim 10, wherein the at least one instruction is performed to determine surface heights of each pixel of the surface height map, based on at least one of a color and a brightness of each pixel of the texture image.

12. The apparatus of claim 10, wherein the at least one instruction is performed to determine whether or not each of the cross-section segments includes the area on which the surface height map is projected, and correct the shape of the cross-section segment including the area on which the surface height map is projected.

13. The apparatus of claim 10, wherein the at least one instruction is performed to correct a shape of a side surface of at least the portion among the cross-section segments.

14. The apparatus of claim 13, wherein the at least one instruction is performed to correct positions of points on border of the cross-section segment included in the area on which the surface height map is projected, among vertices included in the side surface of the cross-section segment.

15. The apparatus of claim 13, wherein the at least one instruction is performed to determine surface heights of each of vertices included in the area on which the surface height map is projected, using the surface height map, and correct positions of each of points on border of the cross-section segment, based on the surface heights of each of vertices.

16. The apparatus of claim 15, wherein the surface heights of each of points on border of the cross-section segment are determined as surface heights of pixels corresponding to the vertices in the surface height map, respectively.

17. The apparatus of claim 15, wherein the surface heights of each of points on border of the cross-section segment are determined by a linear sum of surface heights of pixels corresponding to the vertices in the surface height map, respectively, and surface heights of pixels adjacent to positions on which the vertices are mapped, respectively.

18. The apparatus of claim 10, further comprising:
an input interface device configured to receive reference point information for setting a projection position of the surface height map in the 3D model; and
an printing interface device configured to display the 3D model, the reference point, and projection position of the surface height map,
wherein the at least one instruction is performed to determine the area on which the surface height map is projected, based on the reference point and a border shape of the texture image.

19. A 3D printer comprising:
a processor;
a memory configured to store at least one instruction executed through a learning database and the processor; and
a manufacturing apparatus configured to manufacture an object in a shape determined by an instruction of the processor,
wherein the at least one instruction is performed to:
generate a 3D model of the object;
generate a surface height map from a texture image indicating a surface texture of the object;
set an area in which the surface height map is projected on a surface of the 3D model;
slice the 3D model into a plurality of cross-section segments; and
correct a shape of at least a portion among the cross-section segments in consideration of the area in which the surface height map is projected on the 3D model.

20. The 3D printer of claim 19, wherein the manufacturing apparatus manufactures the object by laminating materials in a shape corresponding to each of cross-section segments from a cross-section segment positioned at the lowermost end among cross-section segments of which the correction is completed.
